(19) United States
(12) Patent Application Publication
(10) Pub. No.: US 2026/0200440 A1
(43) Pub. Date: Jul. 16, 2026

(54) EMBOSSED FOAM CAR WASH BRUSH

(71) Applicant: Erie Brush & Manufacturing Corp., Chicago, IL (US)

(72) Inventor: Jason Ugent, Arlington Heights, IL (US)

(73) Assignee: Erie Brush & Manufacturing Corp., (omitted)

(21) Appl. No.: 19/022,309

(22) Filed: Jan. 15, 2025

(51) Int. Cl. B60S 3/06; A46B 9/00; A46B 13/00; A46B 13/02; D01D 5/42

(52) U.S. Cl. CPC B60S 3/063; A46B 9/005; A46B 13/005; A46B 13/02; D01D 5/426; A46B 2200/3046; D10B 2401/10; D10B 2503/00

(57) ABSTRACT

A vehicle wash brush made of closed cell foam and having a series of ridges or grooves embossed on the fingers or strips of the brush, to facilitate vehicle cleaning.

### BACKGROUND OF THE INVENTION

The present invention generally relates to a vehicle wash brush and, more specifically, to a vehicle wash brush made of closed cell foam whose work surfaces are embossed.

The brush material used in a car wash is important for a number of reasons, including wash effectiveness, cost, speed, and avoiding any damage to the vehicle. Many car washes utilize car wash brushes consisting of sewn-and-stitched cloth attached onto a plastic spine that is inserted into a C-channel aluminum core. These types of cloth vehicle wash brushes suffer from various disadvantages, including a proclivity to damage the vehicle surface since the cloth material absorbs liquid, including dirty water, that may contain impediments that can scratch the vehicle's paint surface.

Closed cell foam was introduced to the car wash industry in the late 1990s and has proven effective. The new automotive clear paint coats are more environmentally friendly, as they are primarily water-based and use less volatile organic compounds compared to the older, more solvent-based paints; however, they can feel “soft” due to the different chemical composition which may not be as hard and resistant to scratches as older clear coats. Closed cell foam enables dirt and grime to be wiped away, while being substantially impervious to liquids due to its tightly sealed cell structure; this inhibits dirt from becoming embedded in the foam material, which can otherwise mark up the soft clear paint coats of vehicles. Another advantage of closed cell foam is a reduction in weight, as opposed to cloth, which means less wear and tear on the car wash equipment and the need for less energy to operate.

Closed cell foam suffers from some disadvantages as a vehicle brush cleaner. Since it is relatively light and smooth, it can sometimes allow embedded dirt and grime to be released without removing it from the vehicle exterior.

Accordingly, there is a need for an improved closed cell foam car wash brush that retains the inherent advantages of the closed cell foam material while providing additional cleaning advantages.

### SUMMARY OF THE INVENTION

The objects mentioned above, as well as other objects, are solved by the present invention, which overcomes disadvantages of prior car wash brushes using closed cell foam, while providing new advantages not previously associated with them. This summary is provided to introduce a selection of concepts in a simplified form that are further described below in the Detailed Description, so that the claimed invention may be better understood. However, this summary is not intended to limit the scope of the claimed subject matter.

In a preferred embodiment of the present invention, a vehicle wash brush is provided, and includes a plurality of brush fingers or strips extending from a rigid core. The brush fingers or strips are made of closed cell foam, and are embossed, creating a series of ridges and adjacent grooves on the surface of the brush fingers or strips, and preferably running generally perpendicular to the length of the fingers or strips. In one preferred embodiment, the series of ridges and adjacent grooves form a wave-like pattern, with the ridges extending above the adjacent grooves on the surface of the brush fingers or strips at least about 1 millimeter. In a particularly preferred embodiment, the closed cell foam has a density of at least 8 lb/ft³, a thickness of between about 3.2-6.35 mm., and the brush fingers or strips are embossed on both sides of the foam.

The vehicle wash brush of the present invention can be used in various types of vehicle washes. In one example, the embossed brush simultaneously rotates and sweeps transversely across a vehicle as the vehicle moves through the vehicle wash bay. In another example, the embossed brush performs a similar movement across a stationary vehicle in a vehicle wash bay.

A method for manufacturing a vehicle wash brush made of closed cell foam also forms part of the present invention. A sheet of closed cell foam is presented to the embossing machine. The sheet of foam is first heated, and then threaded between two rollers of the embossing machine, which thereby embosses at least one surface of the sheet of foam with a series of ridges and adjacent grooves. The embossed sheet of foam is then cut to provide a brush with a plurality of embossed fingers or strips. This brush is then located in a vehicle wash bay of an automatic vehicle wash machine, and the embossed brush fingers or strips are preferably oriented so that the embossed ridges and adjacent grooves are generally perpendicular to the direction in which the brush fingers or strips contact the vehicle surface. In one example, the closed cell foam has a density of at least 8 lb/ft³, and the brush fingers or strips have a thickness of between about 3.2-6.5 mm.

### DEFINITION OF CLAIM TERMS

The terms used in the claims of the patent are intended to have their broadest meaning consistent with the requirements of law. Where alternative meanings are possible, the broadest meaning is intended. All words used in the claims are intended to be used in the normal, customary usage of grammar and the English language.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a top and side partial perspective view of an embossing machine that may be used in connection with the present invention;

FIG. 2 is a front and side partial perspective view of the embossing machine shown in FIG. 1;

FIG. 3 is a partial planar perspective view of a particularly preferred embodiment of a foam brush of the present invention;

FIG. 4 is a schematic top view of wave dimensions embossed on foam brush fingers or strips, for the particularly preferred foam brush embodiment of FIG. 3;

FIG. 5 is a schematic view from the side of FIG. 4, showing the embossed wave dimensions on the surface of the foam brush;

FIG. 6 is a planar perspective view of the embossed foam car wash brush of the present invention, an exploded view of which (prior to cutting in strips/fingers) is shown in FIG. 3;

FIG. 7 is a planar perspective view of the foam car wash brushes of FIG. 6 being used in a car wash;

FIG. 8 is a planar perspective view of an alternative embodiment of a foam brush according to the present invention;

FIG. 9 is a planar perspective view of yet another alternative embodiment of a foam brush according to the present invention; and

FIG. 10 is a schematic diagram showing testing results as discussed below.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

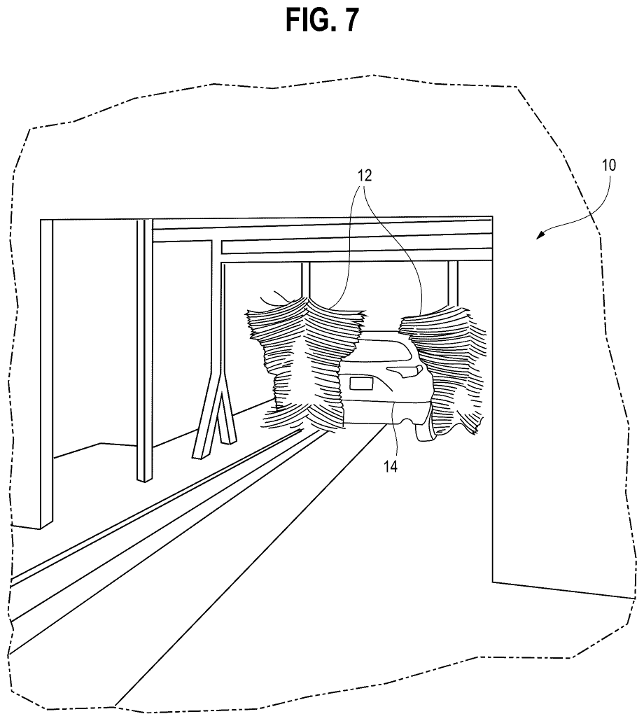

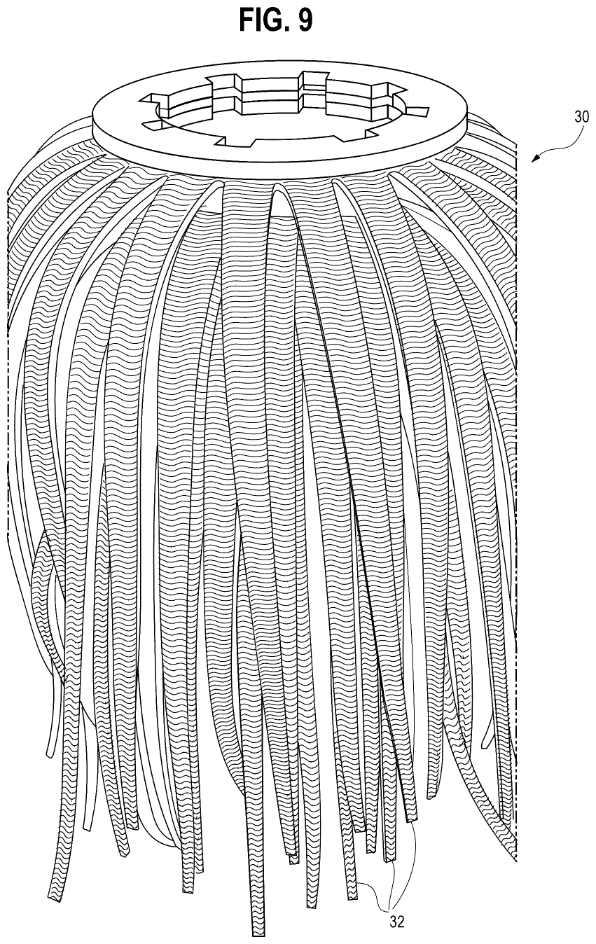

Automatic vehicle brushes can be constructed be in a number of different ways. For example, foam materials can be attached to a plastic spline that slides into a metallic (e.g., aluminum) C-channel core. The foam brush may be cut, forming a plurality of foam brush fingers used for washing. The fingers may be of various sizes. It will therefore be appreciated that the vehicle foam wash brush of the present invention can be used in any variety of automatic vehicle wash machines, including but not limited to: friction wash machines such as tunnel-type car wash machines in which the vehicle moves through the wash bay, as shown in FIG. 7; in-bay or rollover car wash machines in which the vehicle is stationary within the wash bay; and stacked foam brushes glued together and slid onto an aluminum core. (Stacked foam brushes 30, such as shown in FIG. 9, often have 4 sets of fingers 32, with each set containing 6 fingers and being glued/sandwiched between foam spacer pieces; these pieces can have different shapes depending on the OEM and the shape of the aluminum core it slides onto. The overall diameter of this brush is often anywhere from 48″-70″ depending on the type of brush and OEM specifications.) The present invention can also be used in the form of top brushes or side brushes, including wraps, van highs, rockers or other side brush variations.

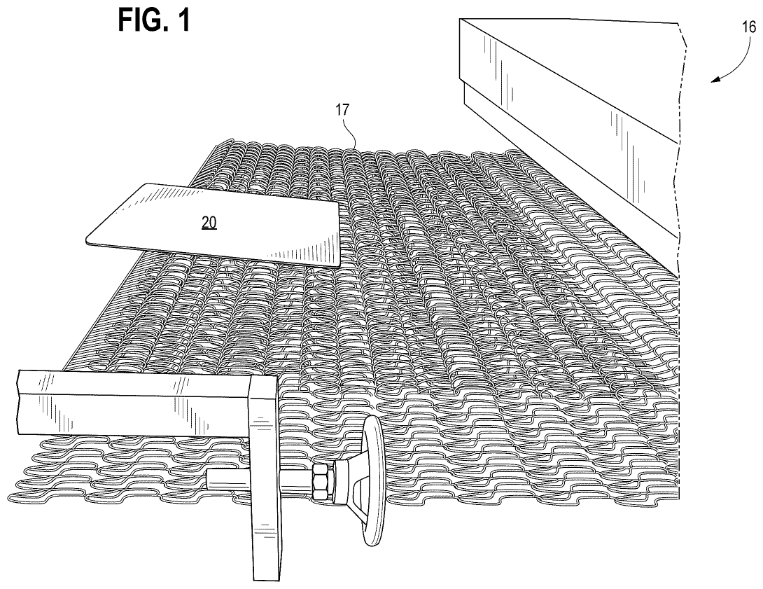

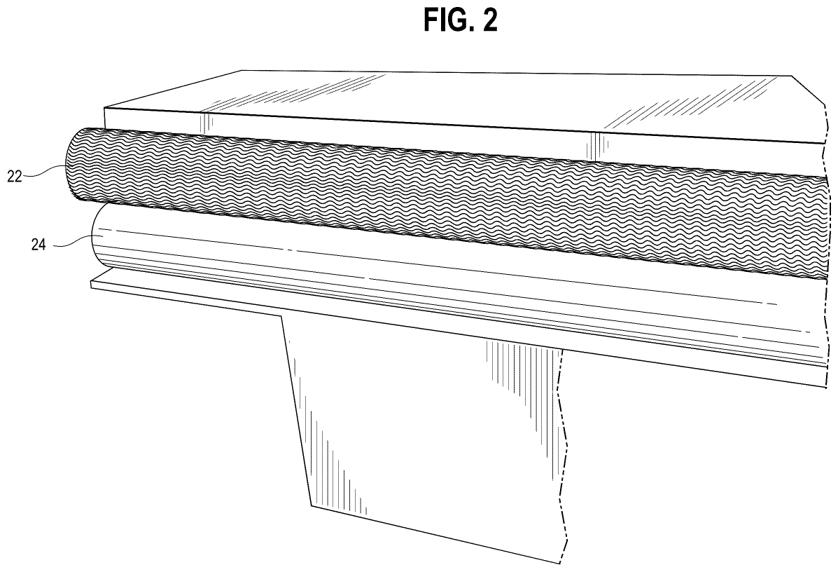

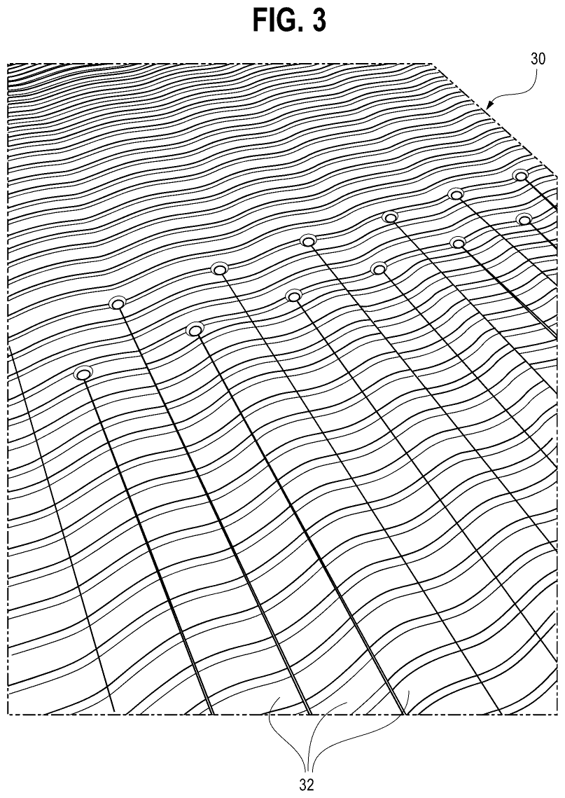

Referring to FIG. 7, an exemplary drive-through car wash 10 is shown in which the car moves through the car wash, and vertical car wash brushes 12 simultaneously rotate and sweep across the front of the vehicle 14 as it moves through the car wash. Preferably the brushes are made of a closed cell foam material that is relatively strong and dense, such as an 8-pound density foam (8 pounds/ft³). Referring to FIGS. 1-2, an embossing machine 16, such as the EVA embossing machine shown at www.jieruimai.com and available at JRM Foamtek (Wuxi Jieruimai International Trade Co. Ltd. of China), may be used, with a sheet of foam 20 heated by a heating element 17 and then squeezed between the two rollers 22 (an embossing roller), 24 (a flat roller). In one preferred embodiment, a series of embossed waves is provided on the foam brush material at locations both above and below where the individual ends of the brush are cut into strips, as shown in FIG. 3. The resulting foam car wash brush 30 with individual, embossed filaments 32 may have general dimensions of 6″-14″ in width and 16″-35″ in length, although these dimensions can vary from this depending upon the type of car wash and type of vehicles being wash (e.g., trucks versus cars).

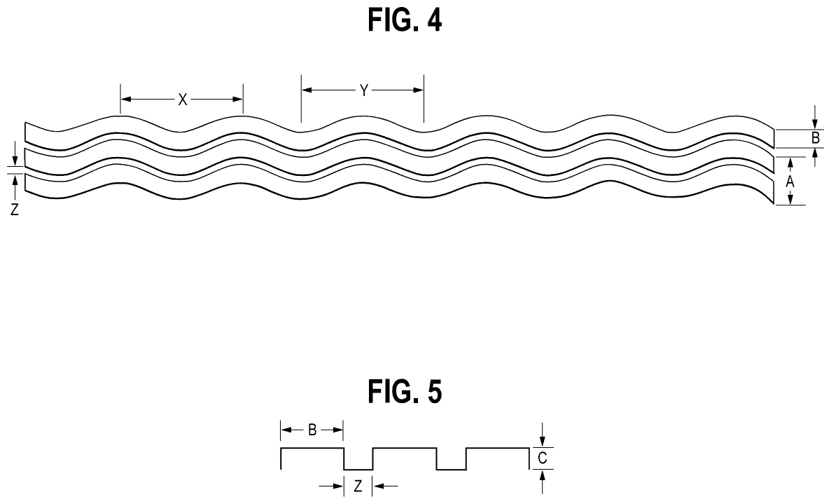

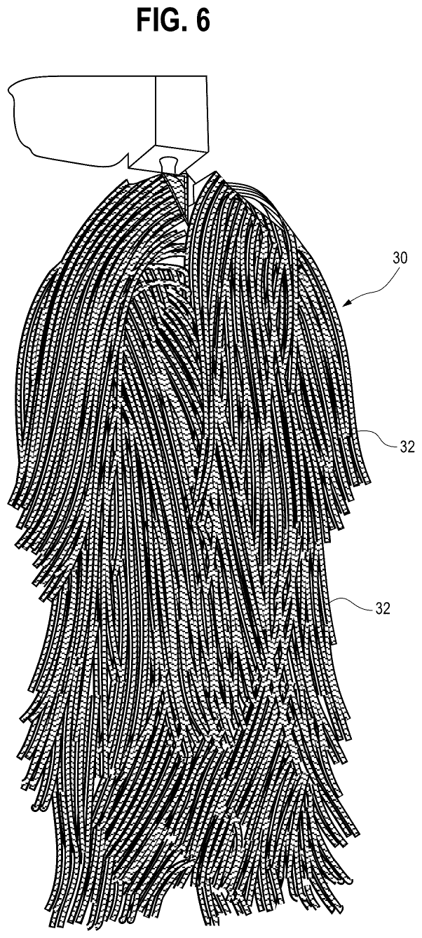

In a particularly preferred embodiment, embossing roller provides the embossed waves shown in FIG. 3-5. Referring to FIG. 4, these waves may have a crest-to-crest distance “X” of 23 mm, a trough-to-trough distance “Y” of 23 mm, an individual, constant wave thickness “B” (i.e., the thickness of the “ridge”) of 3.3 mm, and a constant distance between adjacent waves “Z” (i.e., the thickness of the adjacent “groove”) of 1.5 mm (resulting in distance “A” being 8.1 mm). Referring now to FIG. 5, a side view of the waves, the dimensions may be as shown, with the height “C” of the waves (i.e., their distance below the non-embossed portion of the top surface of the foam brush fingers or strips) being about 0.8-0.9 mm.

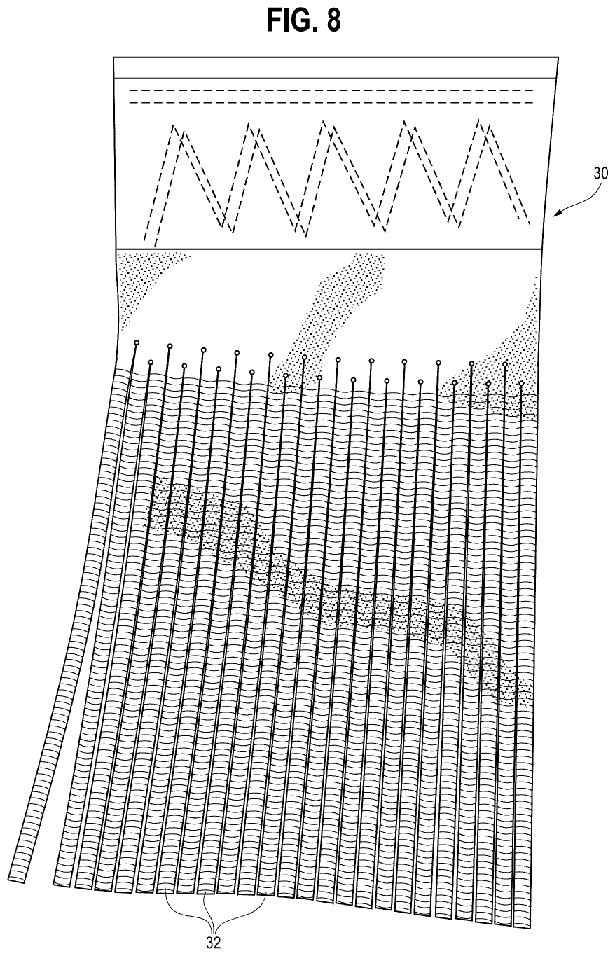

Alternative vehicle foam brush embodiments are shown in FIGS. 8-9.

It was discovered that the embossed wave pattern provides a series of ridges (i.e., protuberances) and adjacent grooves (i.e., troughs) and, particularly if oriented in a direction generally perpendicular to the direction in which the brush fingers or strips are oriented when they contact the vehicle surface, allow the brush fingers or strips to be better able to grab dirt and grime than non-embossed foam. The wave pattern can be shallow, as shown, or can have a steeper angle and be more triangular (not shown), and still work relatively effectively to facilitate the brush fingers or strips to wash dirt and grime from the vehicle.

It was also found, surprisingly, that embossing heat-seals the surface of the foam, creating a sealed layer that provides increased strength and resilience; in other words, rather than decreasing the strength and resilience of the foam in this area, embossing does not detract from and may actually increase the tear strength of the foam.

A vehicle wash brush made of 8-pound density foam and with the series of embossed wave ridges and adjacent grooves on both sides of the brush filaments and having the characteristics in the drawings and as described above, was tested as to tensile strength, tear strength, and elongation, and these test results were compared to plain (non-embossed) and one-side wave configuration brushes. (The wave pattern (H) indicates horizontal, consistent with the orientation of the brush as shown in the drawings. The wave pattern (V) indicates the wave pattern is vertical.)

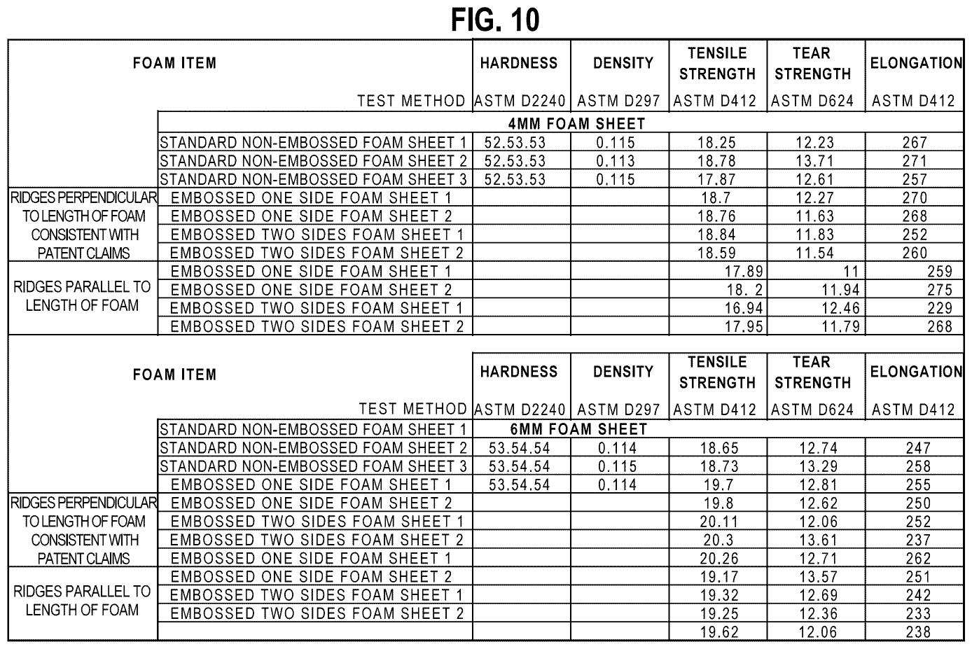

As shown with the test results in FIG. 10, for the 2-sided embossed brush with a 6 mm. thickness, in addition to revealing about a 5-10% increase in tensile strength versus the plain (non-embossed) brush, surprisingly had no substantial decrease in tear strength. For the 4 mm. thickness brush, there was no substantial difference in tensile strength, although tear strength was slightly lower for the embossed brush versus the plain brush.

Within a vehicle wash application with water and chemical applied, the ridges and adjacent grooves created on the surface of the foam by the embossing process, will innately remove dirt particles by way of viscous friction, defined as the force between surfaces (in this case the embossed foam and dirt particles) in relative motion through the fluid (i.e., water and surfactants in a vehicle wash).

Designs or patterns other than waves may be used, although preferably the embossed ridges or grooves are oriented in a direction generally perpendicular to the direction in which the brush contacts the vehicle surface.

The above description is not intended to limit the meaning of the words used in the following claims that define the invention. Persons of ordinary skill in the art will understand that a variety of other designs still falling within the scope of the following claims may be envisioned and used. It is contemplated that these additional examples, as well as future modifications in structure, function, or result to that disclosed here, will exist that are not substantial changes to what is claimed here, and that all such insubstantial changes in what is claimed are intended to be covered by the claims.

I claim:

1. A vehicle wash brush made of closed cell foam, comprising:
a plurality of brush fingers or strips extending from a rigid core, for washing a vehicle, wherein the brush fingers or strips are made of closed cell foam, and wherein the brush fingers or strips are embossed, creating a series of ridges and adjacent grooves onat least an upper or opposing lower surface of the brush fingers or strips, and wherein the series of ridges and adjacent grooves are oriented in a direction generally perpendicular to the longitudinal orientation of the brush fingers or strips as they contact surfaces of the vehicle using viscous friction to clean the vehicle surfaces in the presence of water and surfactants during washing.

2. The vehicle wash brush of claim 1, wherein the series of ridges and adjacent grooves form a wave-like pattern.

3. The vehicle wash brush of claim 1, wherein the series of ridges and adjacent grooves extend below a top surface of the brush fingers or strips at least about 1 millimeter.

4. The vehicle wash brush of claim 1, wherein the closed cell foam has a density of at least 8 lb/ft³.

5. The vehicle wash brush of claim 1, wherein the brush fingers or strips are embossed on both upper and opposing lower surfaces of the foam.

6. The vehicle wash brush of claim 1, wherein the embossed brush simultaneously rotates and sweeps transversely across a vehicle as the vehicle moves through a vehicle wash bay.

7. The vehicle wash brush of claim 1, wherein the embossed brush simultaneously rotates and sweeps transversely across a vehicle as the vehicle is stationary within a vehicle wash bay.

8. The vehicle wash brush of claim 1, wherein the brush has a thickness of between about 3.2-6.35 mm.

9. A method for manufacturing a vehicle wash brush made of closed cell foam, comprising the steps of:
presenting a sheet of closed cell foam to an embossing machine, and thereby heating the sheet of foam;
feeding the heated sheet of foam between two rollers of the embossing machine, and thereby embossing at least one surface of the sheet of foam with a series of ridges and adjacent grooves;
cutting the embossed sheet of foam to provide a brush with a plurality of embossed fingers or strips;
locating the brush in an automatic vehicle wash machine, with the brush fingers or strips oriented so that the series of embossed ridges and adjacent grooves are generally perpendicular to the longitudinal orientation of the brush fingers or strips as the fingers or strips contact surfaces of the vehicle using viscous friction to clean the vehicle surfaces in the presence of water and surfactants during washing.

10. The method of claim 9, wherein the closed cell foam has a density of at least 8 lb/ft³.

11. The method of claim 9, wherein the brush fingers or strips have a thickness of about 3.2-6.5 mm.
